(19) United States
(12) Patent Application Publication
(10) Pub. No.: US 2003/0135469 A1
(43) Pub. Date: Jul. 17, 2003

(54) Wireless local network finance system

(75) Inventor: Geng-Horng Chung, Tao-Yuan City (TW)

Correspondence Address: BACON & THOMAS, PLLC, 625 SLATERS LANE, FOURTH FLOOR, ALEXANDRIA, VA, 22314

(73) Assignee: Kent T.J. Hsu, Taipei (TW)

(21) Appl. No.: 10/043,130

(22) Filed: Jan. 14, 2002

(51) Int. Cl. G06F 17/60; H04K 1/00; H04L 9/00

(52) U.S. Cl. 705/67

(57) ABSTRACT

This invention is a “Wireless local network financial system facility”. It is device for identifying the real identity of a person and thus to prevent credit card frauds. The system consists of a card access portion, two palmprint-identifying portions and a wireless local network card. When a user withdraws cash through the card access portion, the palmprint data of the user will be identified at the same time. Besides, the data will be sent to a financial center database to identify the identity of the user. Only the check is approved, the procedure of card access and withdrawing cash just can be finished. Therefore, the rights and the liabilities of stores and banks can be secured, and all meaningless loss can be protected.

### BACKGROUND OF THE INVENTION

1. Field of the Invention

A fast, convenient and wireless security card access control system for identifying a person precisely.

2. Description of the Related Art

Currently, a credit card reading machine is a unique function machine for identifying a credit card. A cardholder will use a credit card instead of cash to purchase merchandise in a store. Nevertheless, in the transaction using a credit card, only the card and the signature of the cardholder are identified. When using a traditional credit card reading machine (as shown in FIG. 4), someone can copy or capture the information of the card easily. In addition, if a credit card is forged and used for consuming not by the cardholder, the stores selling the merchandise and the financial institute issuing the credit card will suffer the loss. Consequently, a very complicated procedure will be needed to settle the dispute and the social cost and turbulence will be increased.

### SUMMARY OF THE INVENTION

The major object of the invention is that the system can be installed and used at any place conveniently by using wireless transmission through a local area network card installed in the body of the card reading part of the system.

Providing the mechanism to prevent a fraud from using a forged credit card for consuming to indeed protect the benefits of stores and financial institutes issuing credit cards is another object of this invention.

Using a wireless local network card and output/input T1 line to form a type, which is one host to multiple slaves, to expand the values of the business is the third object of the invention.

Furthermore, during the procedure of using a credit card,

### BRIEF DESCRIPTION OF THE DRAWING

FIG. 1. The diagram of the financial system of the invention

FIG. 2. The block diagram of the security system, for identifying the identity of a person, of the invention

FIG. 3. The construction diagram of the wireless local network system of the invention

FIG. 4. The diagram of a traditional credit card reading machine

### DETAILED DESCRIPTION OF THE PREFERRED EMBODIMENT

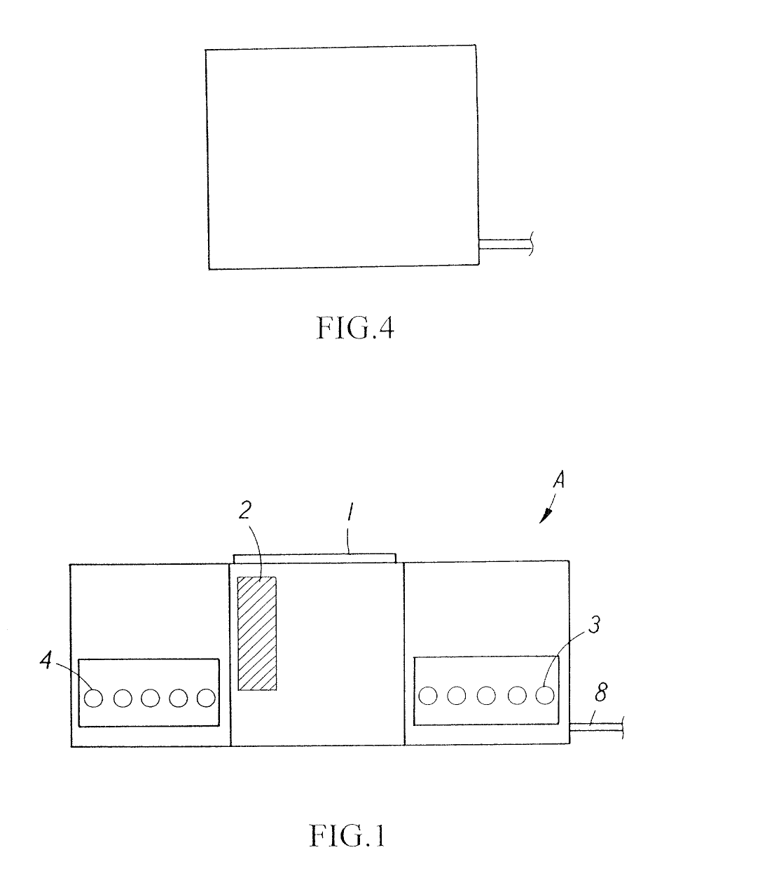

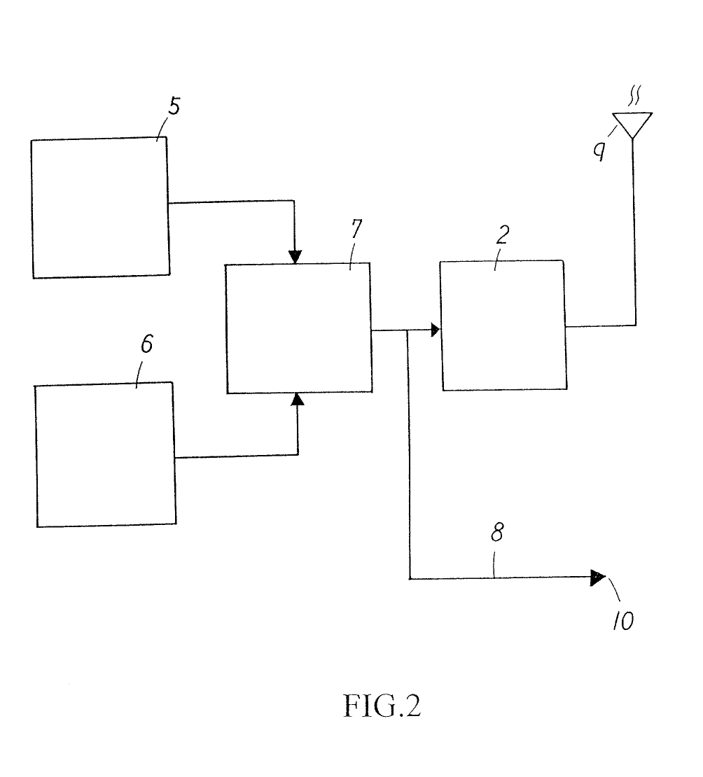

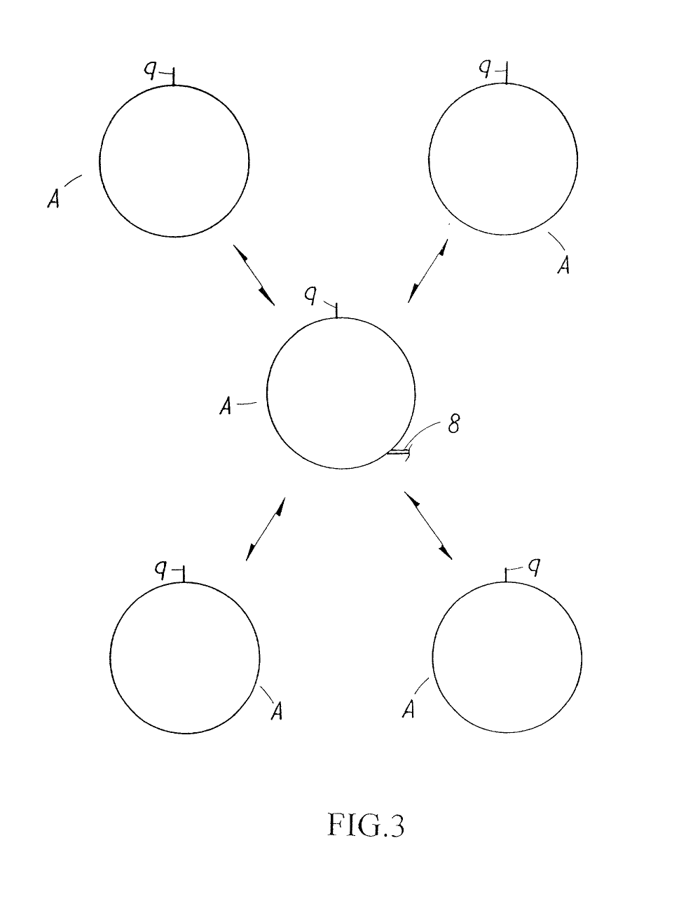

Please refer to FIG. 1, FIG. 2 and FIG. 3. The financial system facility (A) includes card reading portion (1) (or withdrawing portion), wireless local network card portion (2) the portion for identifying the palmprint of the right hand (3) and the portion for identifying the palmprint of the left hand (4). Please refer to FIG. 2 first. The portion for identifying the palmprint of the right hand (3) and the portion for identifying the palmprint of the left hand (4) can transmit the palmprint of a consumer to the database of the financial center through the palmprint data processor (5). The data will be compared with the data of the cardholder in the financial center database to identify the identity of the card user. Only the identity of a cardholder and the data of the card are confirmed, the transaction of a credit card is allowed to be proceeded. FIG. 3 is the block diagram of the security system, for identifying the identity of a person, of the invention. Among the figure, palmprint data processor (5) is a device to transmit an optical palmprint structure to a programmable processor and to transfer the structure data into a transmissible digital signal. Cooperating with the digital signal of card data processor (6), both signals will be sent to the comprehensive data processor (7) by parallel and the comprehensive data processor will transform the signals into a communication protocol, a transmissible serial information. The serial information will be sent to the financial center database (10) of the financial institute, issuing the credit card, through the communication cable, output/input T1 (8). After the information is checked and approved by the financial center database, the approved information will be sent back through the communication cable, output/input T1 (8), to finish a save activity of withdrawing cash and the transaction with a credit card.

Comparing the above method with the traditional method, which only checks the signature no matter who own the credit card when using a traditional a card access machine, the above method increases the save mode enormously. Through a wireless transmission, the financial system facility (A) can be located at any place. The character increases the convenience of the system. Please refer to FIG. 4. As the figure shown, a host of the financial system facility (A) may be located in a certain area with many slaves of the financial system facility (A). Because the slaves may be moved freely, the system provides a convenient operation method for stores. Because each financial system facility (A) of the invention possesses a wireless local network card (2) and an output/input T1 cable (8), each invention can serve as a host or a slave. When an invention will serve as a host, the financial system facility (A) of the invention has to be linked with a financial center database (10) with the output/input T1 cable (8). The financial system facility (A) of other slaves only has to be linked with the financial system facility (A) of the host to transfer information each other through a wireless local network card (2). Then, the financial system facility (A) of the host can transmit the information to the financial center database (10) through the output/input T1 cable (8). Meantime, the financial system facility (A) of the host can establish the network with the financial system facility (A) of the slaves in the same area in advance.

The financial system facility (A) of the invention consists of wireless local network (2), free-movement card access portion (1), the portion for identifying the palmprint of the right hand (3) and the portion for identifying the palmprint of the left hand (4). The function of the financial system facility (A) is to identify the real identity of a cardholder. As to the use of the card access portion (1), the activity of reading a financial card, including the procedure of withdrawing cash certainly, can protect the transaction of using a credit card and prevent stores and financial institutes from the loss of money and merchandise. In addition, The wireless local network card (2) is a new and standard communication protocol. The network card uses ISM 5.7 GHZ frequency. The common frequency has superiors of wide band, high speed, high transmission capability and high communication capability. Because the invention adopts a palmprint-identifying device, the trouble caused by fraud cards can be avoided. Besides, because a wireless local network card is built in the card access portion (1), the card access portion (1) can be moved freely. Thus, the safety and the convenience are increased. From the above descriptions, the invention indeed satisfies the requirements, such as the characteristics of new design, feasibility and improvement, of a new patent. Therefor, I would like to apply for a new patent and I am looking forward to your approval.

What is claimed is:

1. A wireless local network financial system facility, whose financial system facility consists of following portions:
Card access portion: The portion is located at the center of he system and consists of a card data processor and a comprehensive data processor. Its function is to identify a financial card. The procedure of reading a card includes the activity of withdrawing cash.
Wireless local network card: The card is for the wireless receiving and the wireless transmission. The card is built in the interior of the card access portion.
The portion for identifying the palmprint of the right hand and the portion for identifying the palmprint of the left hand: Both portions are located at both sides of the card access portion respectively. The portions include palmprint data processor. Using the card access portion and palmprint identifying portions to identify the real identity of a cardholder, and linking the financial center database through the wireless local network card can protect the activity of consuming with a credit card and prevent stores and financial institutes from the loss of money and merchandise.

2. As the first item of “What is claimed is” says, the financial system facility can be linked with a financial center database through the wireless local network card or through the output/input T1 cable according to requests.
